(19) United States
(12) Patent Application Publication
(10) Pub. No.: US 2008/0291553 A1
(43) Pub. Date: Nov. 27, 2008

(54) Subminiature imaging optical system

(75) Inventors: Tae Young Kim, Seoul (KR); Young Gi Kim, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/068,865

(22) Filed: Feb. 12, 2008

(30) Foreign Application Priority Data
Feb. 12, 2007 (KR) 10-2007-14393

(51) Int. Cl. G02B 9/34

(52) U.S. Cl. 359/774

(57) ABSTRACT

There is provided a subminiature imaging optical system including, sequentially from an object side to an image side: a first lens having positive refractive power; a second lens having negative refractive power and both sides concaved toward an image side; a third lens having positive refractive power and a meniscus shape with a convex image-side surface; and a fourth lens having positive refractive power. The first and second lenses have refractive power satisfying following condition 1, the second lens has a shape satisfying following condition 2, and the third and fourth lenses have refractive power satisfying following condition 3,

0.3<|f1/f2|<2.0 condition 1,

0.2<|R5/f2|<<4 condition 2,

0<|f3/f4|<10 condition 3,

where f1 is a focal length of the first lens, f2 is a focal length of the second lens, f3 is a focal length of the third lens and f4 is a focal length of the fourth lens, and R5 is a radius of curvature of an image-side surface of the second lens.

### CROSS-REFERENCE TO RELATED APPLICATIONS

This application claims the priority of Korean Patent Application No. 2007-14393 filed on Feb. 12, 2007, in the Korean Intellectual Property Office, the disclosure of which is incorporated herein by reference.

### BACKGROUND OF THE INVENTION

1. Field of the Invention

The present invention relates to a subminiature imaging optical system, and more particularly, to a subminiature imaging optical system installed in a mobile communication terminal and a personal digital assistant (PDA) or utilized in a surveillance camera and a digital camera.

2. Description of the Related Art

Recently, regarding an image pickup system, studies have been conducted on camera modules for telecommunication terminals, digital still cameras (DSCs), camcorders, and personal computer (PC) cameras which are attached to personal computers as an imaging device. Here, an image-forming lens system is the most important component of such an image pickup system to obtain an image.

The lens system needs to be high-performing in terms of resolution and image quality, thus complicating a lens configuration. However, such structural and optical complexity leads to increase in size, posing a difficulty to compactness and thinness of the lens system.

For example, a camera module should necessarily be miniaturized to be installed in a mobile phone more efficiently. Also, a charge coupled device (CCD) or a complementary metal oxide semiconductor (CMOS) used in the camera module as an image sensor is gradually increased in resolution and reduced in pixel size. In turn, the lens system included in the camera module needs to be smaller-sized and thinner while attaining high resolution and superior optical capabilities.

Here, in a case where the CCD or CMOS with 3 million pixels is employed, only three sheets of lenses or less may be arranged to satisfy optical capabilities and miniaturization. However, in a case where three sheets of lenses or less are applied to a high-resolution imaging device such as the CCD or CMOS with at least 5 million pixels, each of the lenses should be increased in refractive power, and thus is hard to be machined. This as a result renders it difficult to achieve both high performance and miniaturization of the lens system. Thus, four sheets of lenses may be employed, but when a spherical lens is utilized in this configuration, the optical lens system is increased in total length, thereby hardly miniaturizable.

Therefore there has been a demand for a lens system for a camera module which can be subminiaturized and realize optical capabilities.

### SUMMARY OF THE INVENTION

An aspect of the present invention provides a subminiature lens system for a camera module which adopts only four sheets of lenses to achieve high resolution and subminiaturization, while performing with excellent optical capabilities.

An aspect of the present invention also provides a lighter subminiature lens system for a cameral module which employs at least three sheets of plastic lenses thereby to be manufactured in mass production at a low cost.

According to an aspect of the present invention, there is provided a subminiature imaging optical system including, sequentially from an object side to an image side: a first lens having positive refractive power; a second lens having negative refractive power and both sides concaved toward an image side; a third lens having positive refractive power and a meniscus shape with a convex image-side surface; and a fourth lens having positive refractive power.

The first and second lenses may have refractive power satisfying following condition 1, the second lens may have a shape satisfying following condition 2, and the third and fourth lenses may have refractive power satisfying following condition 3,

0.3<|f1/f2|<2.0 condition 1,

0.2<|R5/f2|<<4 condition 2,

0<|f3/f4|<10 condition 3,

where f1 is a focal length of the first lens, f2 is a focal length of the second lens, f3 is a focal length of the third lens, f4 is a focal length of the fourth lens, and R5 is a radius of curvature of an image-side surface of the second lens.

At least one of the first and second lenses may be aspherical. The third lens may have at least one surface formed of an aspherical surface. The fourth lens may have at least one surface formed of an aspherical surface.

An aperture stop may be disposed in front of an object-side surface of the first lens.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a lens configuration view illustrating a subminiature imaging optical system according to a first embodiment of the invention;

FIG. 2 is an aberrational diagram illustrating the embodiment shown in FIG. 1, in which A represents spherical aberration, B represents astigmatism and C represents distortion;

FIG. 3 is a graph illustrating modulation transfer function (MTF) characteristics of the embodiment shown in FIG. 1;

FIG. 4 is a lens configuration view illustrating a subminiature imaging optical system according to a second embodiment of the invention;

FIG. 5 is an aberrational diagram illustrating the embodiment shown in FIG. 4, in which A represents spherical aberration, B represents astigmatism and C represents distortion;

FIG. 6 is a graph illustrating modulation transfer function (MTF) characteristics of the embodiment shown in FIG. 4;

FIG. 7 is a lens configuration view illustrating a subminiature imaging optical system according to a third embodiment of the invention;

FIG. 8 is an aberrational diagram illustrating the embodiment shown in FIG. 7, in which A represents spherical aberration, B represents astigmatism and C represents distortion;

FIG. 9 is a graph illustrating modulation transfer function (MTF) characteristics of the embodiment shown in FIG. 7;

FIG. 10 is a lens configuration view illustrating a subminiature imaging optical system according to a fourth embodiment of the invention;

FIG. 11 is an aberrational diagram illustrating the embodiment shown in FIG. 10, in which A represents spherical aberration, B represents astigmatism and C represents distortion; and

FIG. 12 is a graph illustrating modulation transfer function (MTF) characteristics of the embodiment shown in FIG. 10.

### DETAILED DESCRIPTION OF THE PREFERRED EMBODIMENT

Exemplary embodiments of the present invention will now be described in detail with reference to the accompanying drawings.

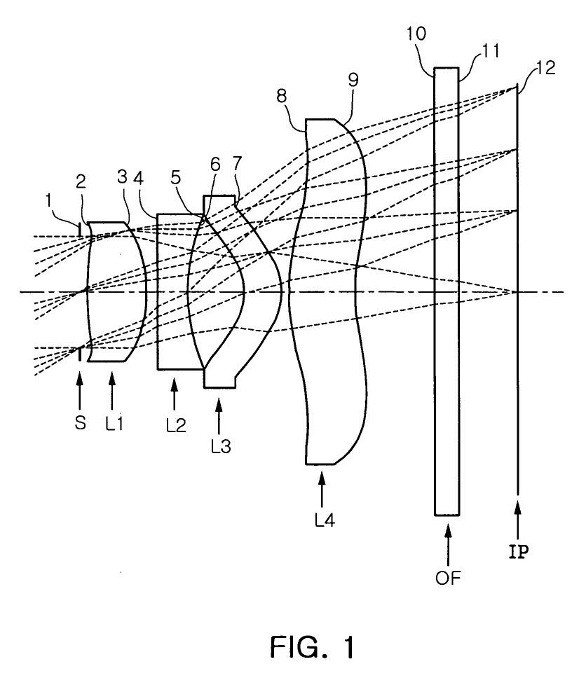

FIG. 1 is a lens configuration view illustrating a subminiature imaging optical system according to a first embodiment of the invention. In the following lens configuration views, the thicknesses, sizes and shapes of the lenses may be exaggerated for clarity. In particular, the shapes of spherical or aspherical surfaces shown in the views are only exemplary and should not be construed as limiting.

As shown in FIG. 1, the subminiature imaging optical system includes a first lens L1 having positive refractive power, a second lens L2 having negative refractive power and both sides concaved toward an image side, a third lens L3 having positive refractive power and a meniscus shape with a convex image-side surface, and a fourth lens L4 having positive refractive power L4. Also, an aperture stop S is disposed in front of an object-side surface of the first lens L1.

Here, the first lens L1, the third lens L3 and the fourth lens L4 may be formed of plastic and the second lens L2 may be formed of glass. Alternatively the first to fourth lenses L1 to L4 may be formed of plastic.

Meanwhile, an optical filter such as an infrared ray filter, a cover glass and the like may be provided between the fourth lens L4 and an image plane IP.

The image plane IP corresponds to an image sensor such as a charge coupled device (CCD) and a complementary metal oxide semiconductor (CMOS).

In the subminiature imaging optical system of the present invention, the aperture stop is disposed in front of the object-side surface of the first lens L1. Also, the lenses of the optical system have refractive power distributed in such a way that the lenses, from the object side, have positive refractive power, negative refractive power, positive refractive power, and positive refractive power, respectively. Such distribution of refractive power enables the subminiature imaging optical system to be superior in field curvature characteristics. Moreover, at least one of the fourth lenses may be formed of a spherical glass lens to easily eliminate chromatic aberration, thereby producing an optical system with high-definition, high-resolution and wide angle of view. Particularly, the aspherical lens adopted enhances definition of the lenses while reducing distortion and spherical aberration, thereby realizing a compact optical system with excellent optical characteristics.

In addition, the aperture stop S is provided in front of the object-side surface of the first lens L1 to thereby restrict an effective aperture of the lenses disposed behind the aperture stop. Furthermore, an exit pupil may be located far toward the object side from a last image-side surface. This lowers a light exit angle and beneficially shortens a length of an overall optical system.

With this overall configuration, operational effects of following conditions 1 to 3 will be examined hereunder.

Condition 1 defines a relationship between a focal length f1 of the first lens L1 and a focal length f2 of the second lens L2, and prescribes refractive power of the first and second lenses L1 and L2.

0.3<|f1/f2 |<2.0 condition 1,

where f1 is the focal length of the first lens L1, and f2 is the focal length of the second lens L2.

Deviation from a lower limit of condition 1 renders astigmatism of the optical system hardly correctable. On the other hand, deviation from an upper limit of condition 1 renders spherical aberration hardly correctable.

Condition 2 defines a relationship between a radius of curvature of an image-side surface of the second lens L2 and the focal length of the second lens L2, and prescribes a shape of the second lens L2.

0.2<|R5/f2|<4 condition 2,

where R5 is the radius of curvature of the image-side surface of the second lens L2 and f2 is the focal length of the second lens L2.

Deviation from a lower limit of condition 2 darkens a peripheral portion due to loss of a peripheral light amount. Meanwhile, deviation from an upper limit of condition 2 increases astigmatism and field curvature to degrade properties of the optical system.

Condition 3 defines a relationship between a focal length f3 of the third lens L3 and a focal length f4 of the fourth lens L4, and governs refractive power of the third and fourth lenses L3 and L4.

0<|f3/f4|<10 condition 3,

where f3 is the focal length of the third lens L3 and f4 is the focal length of the fourth lens L4.

Deviation from a lower limit of condition 3 increases refractive power of the third lens L3, thus rendering off-axis aberration hardly correctable. On the other hand, deviation from an upper limit of condition 3 renders axial chromatic aberration hardly correctable.

Now, the present invention will be examined in greater detail through specific numerical examples.

As described above, in the following first to fourth embodiments, a subminiature imaging optical system includes a first lens L1 having positive refractive power, a second lens L2 having negative refractive power and both sides concaved toward an image side, a third lens L3 having positive refractive power and a meniscus shape with a convex image-side surface, and a fourth lens L4 having positive refractive power L4. Also, an aperture stop S is disposed in front of an object-side surface of the first lens L1. Moreover, an optical filter such as an infrared ray filter, a cover glass and the like may be provided between the fourth lens LG4 and an image plane IP. The image plane IP corresponds to an image sensor such as the CCD and CMOS.

Each of the aspherical surfaces used in each of the embodiments herein is obtained from following Equation 1:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … , \qquad Equation 1$$

where Z is a distance from a vertex of a lens in an optical axis, Y is a distance in a direction perpendicular to the optical axis, C is a reciprocal number of a radius r of curvature at a vertex of the lens, K is a conic constant and A, B, C, D, E and F are aspherical coefficients.

Here, the MTF depends on a spatial frequency of a cycle per millimeter and is defined by following Equation 2 between a maximum intensity and a minimum intensity of light.

$$MTF = \frac{Max - Min}{Max + Min} \qquad Equation 2$$

That is, MTF is most ideal when 1 and a smaller MTF deteriorates resolution.

### First Embodiment

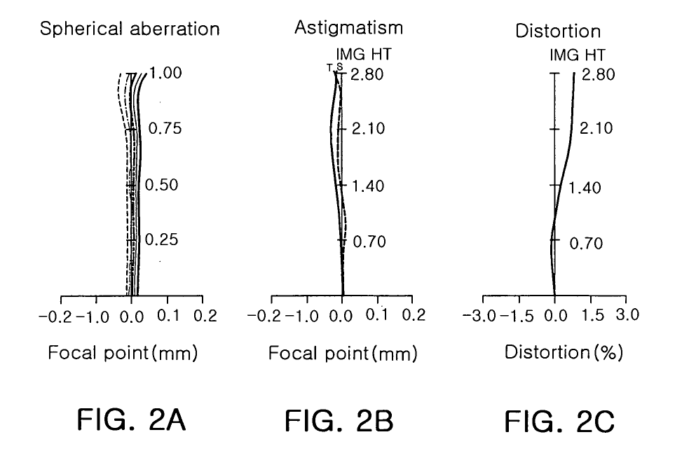

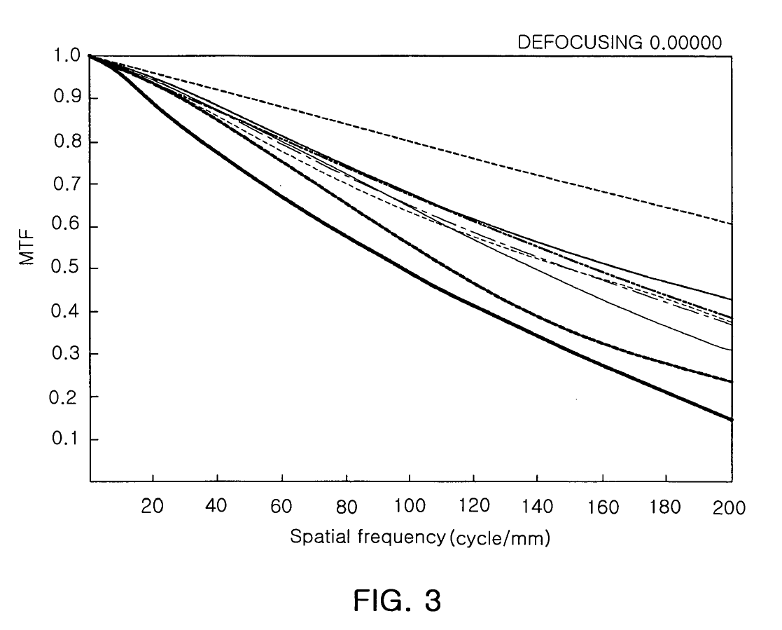

Table 1 below shows numerical values according to a first embodiment of the present invention. FIG. 1 is a view illustrating a lens arrangement of the subminiature imaging optical system according to the first embodiment of the present invention, and FIGS. 2A to 2C show aberrations of the embodiment shown in Table 1 and FIG. 1. FIG. 3 is a graph illustrating MTF characteristics shown in Table 1 and FIG. 1.

In the first embodiment, an F number Fno is 2.9, an angle of view is 66 degrees, a length TL from an object-side surface 2 of the first lens L1 to the image plane 12 is 5.77 mm, and an effective focal length f is 4.44 mm.

TABLE 1

| | | | | Abbe | |
|---|---|---|---|---|---|
| Surface | Radius of | Thickness or | Refractive | number | |
| No | curvature R | distance t | index Nd | Vd | Remark |
| 1 | ∞ | 0.1 | | | Aperture |
| | | | | | stop |
| *2 | 3.10844 | 0.8 | 1.53 | 55.8 | First lens |
| *3 | −2.07297 | 0.137 | | | |
| 4 | 28.1361 | 0.4 | 1.755 | 27.5 | Second lens |
| 5 | 2.50075 | 0.758239 | | | |
| *6 | −0.79631 | 0.5 | 1.53 | 55.8 | Third lens |
| *7 | −0.91331 | 0.1 | | | |
| *8 | 2.5 | 0.9 | 1.53 | 55.8 | Fourth lens |
| *9 | 2.48191 | 1.084789 | | | |
| 10 | ∞ | 0.3 | 1.51 | 64.2 | Optical filter |
| 11 | ∞ | 0.791 | | | |
| 12 | ∞ | 0 | | | Image plane |

In Table 1, * represents an aspherical surface, and in the first embodiment, object-side and image-side refractive surfaces 2 and 3 of the first lens L1, object-side and image-side refractive surfaces 6 and 7 of the third lens L3 and object-side and image-side refractive surfaces 8 and 9 of the fourth lens L4 are aspherical.

Values of aspherical coefficients in the first embodiment according to Equation 1 are noted in Table 2 below.

TABLE 2

| Surface | | | | | | |
|---|---|---|---|---|---|---|
| No | K | A | B | C | D | E |
| 2 | −43.989860 | 0.106600 | −.326466 | 0.336899 | −.257780 | |
| 3 | 3.094136 | 0.234460E−02 | 0.251352E−01 | −.756211E−01 | 0.684855E−01 | |
| 6 | −1.000000 | 0.114012 | −.314359E−01 | −.699715E−01 | 0.103797 | |
| 7 | −1.000000 | 0.672445E−01 | −.163677E−01 | −.126848E−01 | 0.214028E−01 | |
| 8 | −3.631999 | −.408214E−01 | 0.126811E−01 | −.324838E−02 | 0.353419E−03 | −.807023E−05 |
| 9 | −20.366457 | −.193236E−01 | 0.227732E−02 | −.826040E−03 | 0.909376E−04 | −.619649E−05 |

### Second Embodiment

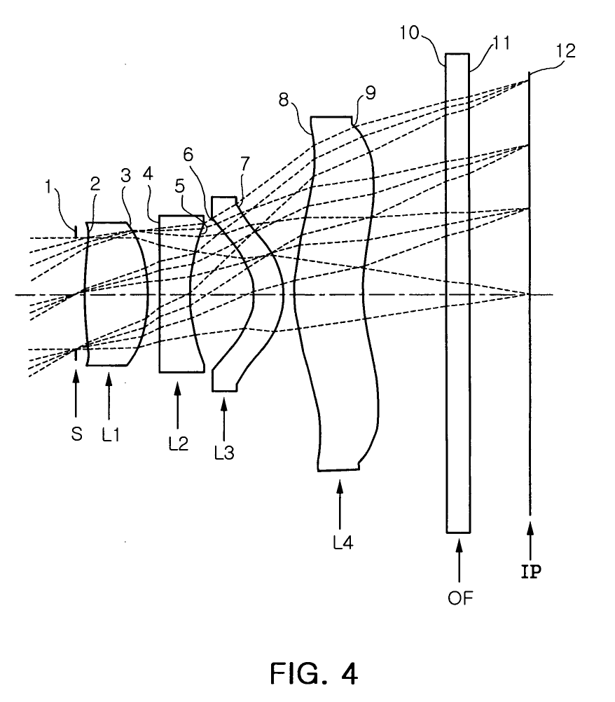

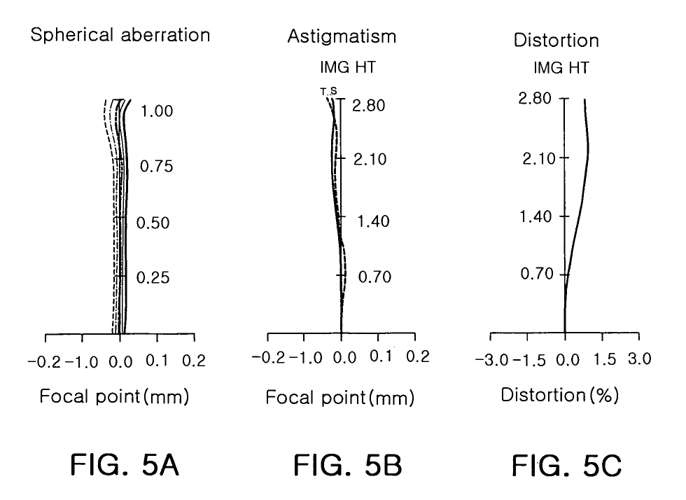

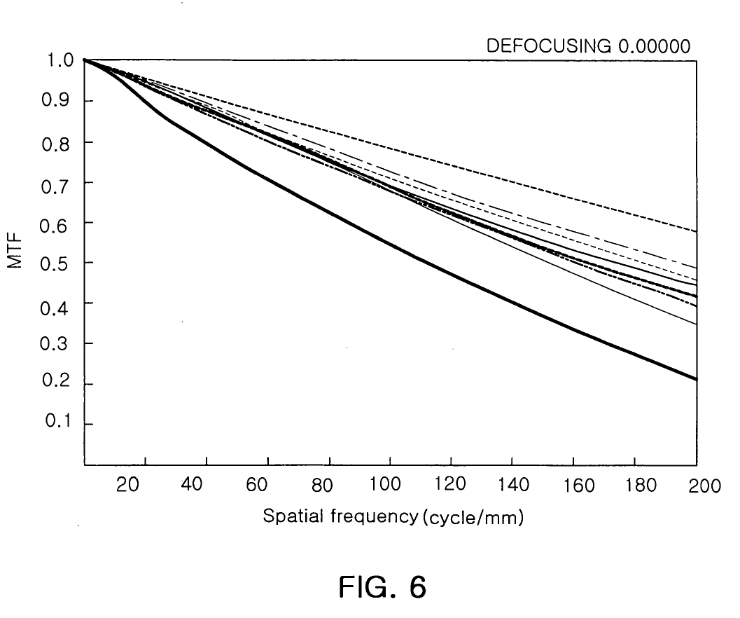

Table 3 below shows numerical values according to a second embodiment of the present invention. FIG. 4 is a view illustrating a lens arrangement of the subminiature imaging optical system according to the second embodiment of the present invention, and FIGS. 5A to 5C show aberrations of the embodiment shown in Table 3 and FIG. 4. FIG. 6 is a graph illustrating MTF characteristics shown in Table 3 and FIG. 4.

In the second embodiment, an F number Fno is 2.9, an angle of view is 64.4 degrees, a length TL from an object-side surface 2 of the first lens L1 to the image plane 12 is 5.9 mm, and an effective focal length f is 4.55 mm.

TABLE 3

| | | | | Abbe | |
|---|---|---|---|---|---|
| Surface | Radius of | Thickness or | Refractive | number | |
| No | curvature R | distance t | index Nd | Vd | Remark |
| 1 | ∞ | 0.1 | | | Aperture |
| | | | | | stop |
| *2 | 3.14827 | 0.83 | 1.53 | 55.8 | First lens |
| *3 | −2.03891 | 0.146256 | | | |
| 4 | 39.9546 | 0.4 | 1.755 | 27.5 | Second lens |
| 5 | 2.50095 | 0.833843 | | | |
| *6 | −0.70393 | 0.4 | 1.54 | 40.97 | Third lens |
| *7 | −0.80713 | 0.130968 | | | |
| *8 | 2.5 | 0.9 | 1.53 | 55.8 | Fourth lens |
| *9 | 2.48191 | 1.084782 | | | |
| 10 | ∞ | 0.3 | 1.51 | 64.2 | Optical filter |
| 11 | ∞ | 0.774 | | | |
| 12 | ∞ | 0 | | | Image plane |

In Table 3, * represents an aspherical surface, and in the second embodiment, object-side and image-side refractive surfaces 2 and 3 of the first lens L1, object-side and image-side refractive surfaces 6 and 7 of the third lens L3 and object-side and image-side refractive surfaces 8 and 9 of the fourth lens L4 are aspherical.

Values of aspherical coefficients in the second embodiment according to Equation 1 are noted in Table 4 below.

TABLE 4

| Surface | | | | | | |
|---|---|---|---|---|---|---|
| No | K | A | B | C | D | E |
| 2 | −45.523044 | 0.108371 | −.326707 | 0.340760 | −.251793 | |
| 3 | 2.973763 | 0.746854E−02 | 0.246363E−01 | −.687347E−01 | 0.686567E−01 | |
| 6 | −1.000000 | 0.139154 | 0.434649E−02 | −.640745E−01 | 0.818770E−01 | |
| 7 | −1.000000 | 0.811931E−01 | 0.398471E−03 | −.905095E−02 | 0.200518E−01 | |
| 8 | −3.631999 | −.403881E−01 | 0.126199E−01 | −.324981E−02 | 0.353223E−03 | −.840314E−05 |
| 9 | −20.366457 | −.198755E−01 | 0.240829E−02 | −.836611E−03 | 0.902706E−04 | −.642035E−05 |

### Third Embodiment

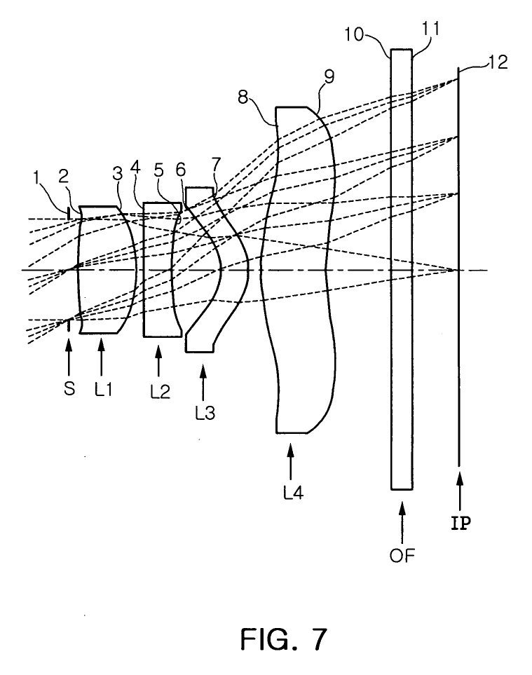

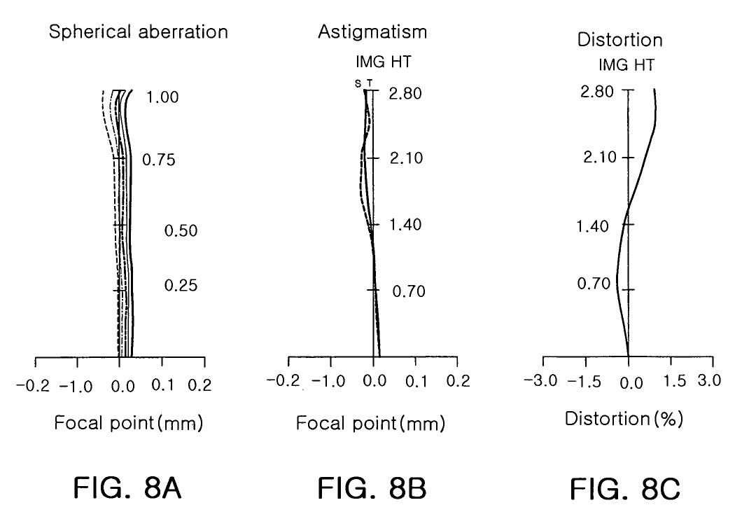

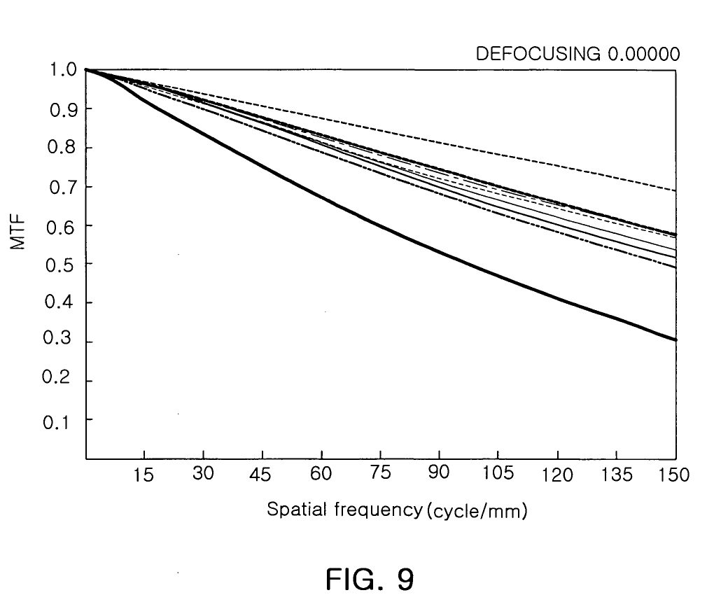

Table 5 below shows numerical values according to a third embodiment of the present invention. FIG. 7 is a view illustrating a lens arrangement of the subminiature imaging optical system according to the third embodiment of the present invention, and FIGS. 8A to 8C show aberrations of the embodiment shown in Table 5 and FIG. 7. FIG. 9 is a graph illustrating MTF characteristics shown in Table 5 and FIG. 7.

In the third embodiment, an F number Fno is 2.8, an angle of view is 65.8 degrees, a length TL from an object-side surface 2 of the first lens L1 to the image plane 12 is 5.6 mm, and an effective focal length f is 4.444 mm.

TABLE 5

| | | | | Abbe | |
|---|---|---|---|---|---|
| Surface | Radius of | Thickness or | Refractive | number | |
| No | curvature R | distance t | index Nd | Vd | Remark |
| 1 | ∞ | 0.1 | | | Aperture |
| | | | | | stop |
| *2 | 2.63918 | 0.857148 | 1.53 | 55.8 | First lens |
| *3 | −1.98682 | 0.100879 | | | |
| 4 | −434.3358 | 0.4 | 1.755 | 27.5 | Second lens |
| 5 | 2.75347 | 0.70808 | | | |
| *6 | −0.67258 | 0.4 | 1.54 | 40.94 | Third lens |
| *7 | −0.80841 | 0.192106 | | | |
| *8 | 2.61538 | 0.946461 | 1.53 | 55.8 | Fourth lens |
| *9 | 2.34434 | 0.927419 | | | |
| 10 | ∞ | 0.3 | 1.51 | 64.2 | Optical filter |
| 11 | ∞ | 0.667896 | | | |
| 12 | ∞ | 0 | | | Image plane |

In Table 5, * represents an aspherical surface, and in the third embodiment, object-side and image-side refractive surfaces 2 and 3 of the first lens L1, object-side and image-side refractive surfaces 6 and 7 of the third lens L3 and object-side and image-side refractive surfaces 8 and 9 of the fourth lens L4 are aspherical.

Values of aspherical coefficients in the third embodiment according to Equation 1 are noted in Table 6 below.

TABLE 6

| Surface | | | | | | |
|---|---|---|---|---|---|---|
| No | K | A | B | C | D | E |
| 2 | −33.087181 | 0.154263 | −.419731 | 0.477972 | −.365690 | |
| 3 | 2.799077 | 0.434327E−02 | 0.263373E−01 | −.824027E−01 | 0.730932E−01 | |
| 6 | −1.000000 | 0.158798 | 0.301625E−01 | −.297628E−01 | 0.578550E−01 | |
| 7 | −1.000000 | 0.104079 | 0.866238E−01 | 0.472347E−01 | −.858570E−02 | |
| 8 | −7.531698 | −.317411E−01 | 0.122108E−01 | −.330684E−02 | 0.371227E−03 | −.103125E−04 |
| 9 | −20.366457 | −.256238E−01 | 0.448040E−02 | −.959916E−03 | 0.719163E−04 | −.482315E−05 |

### Fourth Embodiment

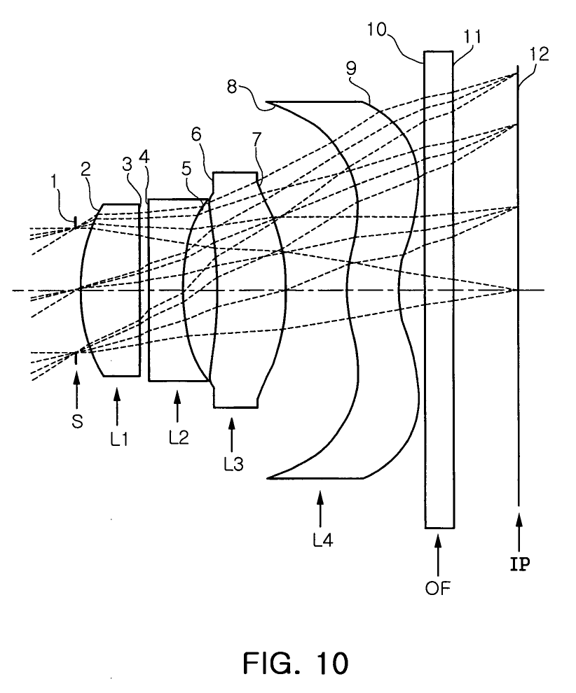

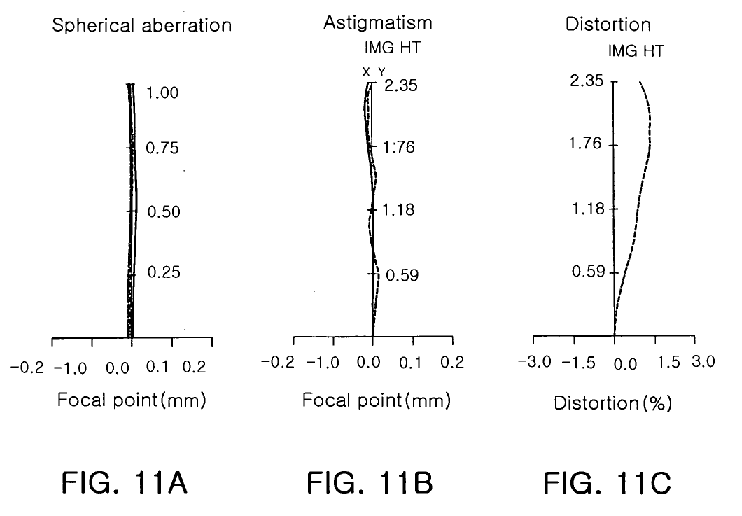

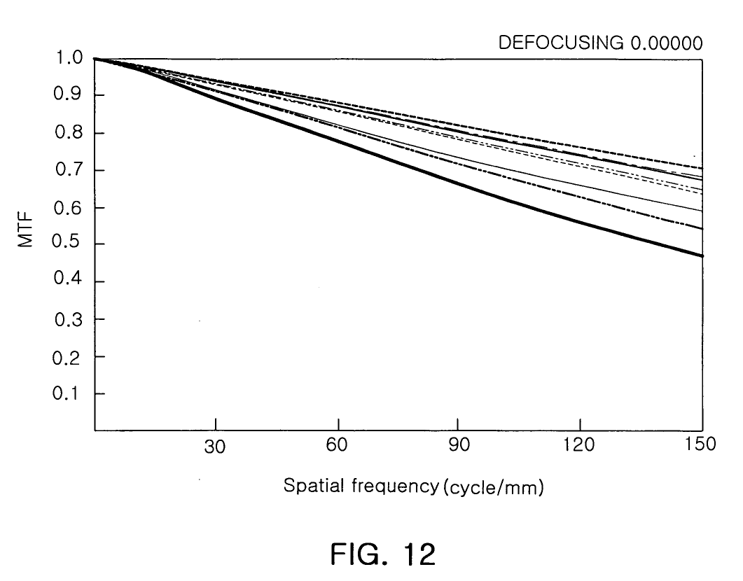

Table 7 below shows numerical values according to a fourth embodiment of the present invention. FIG. 10 is a view illustrating a lens arrangement of the subminiature imaging optical system according to the fourth embodiment of the present invention, and FIGS. 11A to 11C show aberrations of the embodiment shown in Table 6 and FIG. 10. FIG. 12 is a graph illustrating MTF characteristics shown in Table 7 and FIG. 10.

In the fourth embodiment, an F number Fno is 2.8, an angle of view is 62 degrees, a length TL from an object-side surface 2 of the first lens L1 to the image plane 12 is 4.85 mm, and an effective focal length f is 3.9 mm.

TABLE 7

| | | | | Abbe | |
|---|---|---|---|---|---|
| Surface | Radius of | Thickness or | Refractive | number | |
| No | curvature R | distance t | index Nd | Vd | Remark |
| 1 | ∞ | 0.05 | | | Aperture |
| | | | | | stop |
| 2 | 1.87093 | 0.619492 | 1.74 | 49.2 | First lens |
| 3 | ∞ | 0.1 | | | |
| *4 | −17.20577 | 0.358085 | 1.63 | 23.4 | Second lens |
| *5 | 2.57988 | 0.355744 | | | |
| *6 | −8.81676 | 0.728217 | 1.54 | 56.1 | Third lens |
| *7 | −3.94019 | 0.659929 | | | |
| *8 | 1.3489 | 0.55 | 1.54 | 56.1 | Fourth lens |
| *9 | 1.15509 | 0.280414 | | | |
| 10 | ∞ | 0.3 | 1.51 | 64.2 | Optical filter |
| 11 | ∞ | 0.674378 | | | |
| 12 | ∞ | 0 | | | Image plane |

In Table 7, * represents an aspherical surface, and in the fourth embodiment, object-side and image-side refractive surfaces 4 and 5 of the second lens L2, object-side and image-side refractive surfaces 6 and 7 of the third lens L3 and object-side and image-side refractive surfaces 8 and 9 of the fourth lens L4 are aspherical.

Values of aspherical coefficients in the fourth embodiment according to Equation 1 are noted in Table 8 below.

TABLE 8

| Surface | | | | | | |
|---|---|---|---|---|---|---|
| No | K | A | B | C | D | E |
| 4 | 0.000000 | 0.149245E−01 | 0.529595E−02 | −.136041E−01 | 0.879296E−02 | |
| 5 | 0.000000 | 0.282724E−01 | 0.587664E−01 | −.661222E−01 | 0.668223E−01 | |
| 6 | 0.000000 | −.122023 | 0.146045 | −.179758 | 0.147747 | |
| 7 | 8.438373 | −.200823 | 0.229795 | −.155497 | 0.620305E−01 | |
| 8 | −3.656801 | −.240622 | 0.795562E−01 | −.129760E−01 | 0.491936E−03 | |
| 9 | −3.249399 | −.185466 | 0.828448E−01 | −.274480E−01 | 0.524215E−02 | −.465955E−03 |

As can be seen from the above embodiments, the subminiature imaging optical system with excellent aberrational characteristics as shown in FIGS. 2, 5, 8 and 11 is obtained according to the present invention.

In the meantime, values of conditions 1 to 3 for the above first to fourth embodiments are noted in Table 9.

TABLE 9

| | First | Second | Third | Fourth |
|---|---|---|---|---|
| | embodiment | embodiment | embodiment | embodiment |
| Condition 1 | 0.68 | 0.7 | 0.63386 | 0.718483 |
| Condition 2 | 0.69 | 0.71 | 0.766804 | 0.74 |
| Condition 3 | 0.6 | 0.7 | 1.00228 | 0.002 |

As noted in Table 9 above, the first to fourth embodiments of the present invention satisfy conditions 1 to 3.

As set forth above, according to exemplary embodiments of the invention, a subminiature imaging optical system is suitably applicable to subminiature optical instruments such as a mobile phone camera using an image sensor such as a CCD and CMOS. Moreover, lenses of the optical system have respective refractive surfaces adjusted in radius of curvature and adopt an aspherical surface, thereby minimizing various aberrations and attaining an image with high definition and high resolution.

In addition, a number of lenses are formed of plastic to easily manufacture a lighter and lower-cost subminiature imaging optical system in mass production.

While the present invention has been shown and described in connection with the exemplary embodiments, it will be apparent to those skilled in the art that modifications and variations can be made without departing from the spirit and scope of the invention as defined by the appended claims.

What is claimed is:

1. A subminiature imaging optical system comprising, sequentially from an object side to an image side:
a first lens having positive refractive power;
a second lens having negative refractive power and both sides concaved toward an image side;
a third lens having positive refractive power and a meniscus shape with a convex image-side surface; and
a fourth lens having positive refractive power.

2. The subminiature imaging optical system of claim 1, wherein the first and second lenses have refractive power satisfying following condition 1,
0.3<|f1/f2|<2.3 condition 1,
where f1 is a focal length of the first lens and f2 is a focal length of the second lens.

3. The subminiature imaging optical system of claim 1, wherein the second lens has a shape satisfying following condition 2,
0.2<|R5/f2|<4 condition 2,
where R5 is a radius of curvature of an image-side surface of the second lens and f2 is a focal length of the second lens.

4. The subminiature imaging optical system of claim 1, wherein the third and fourth lenses have refractive power satisfying following condition 3,
0<|f3/f4|<10 condition 3,
where f3 is a focal length of the third lens and f4 is a focal length of the fourth lens.

5. The subminiature imaging optical system of claim 1, wherein at least one of the first and second lenses is aspherical.

6. The subminiature imaging optical system of claim 1, wherein the third lens has at least one surface formed of an aspherical surface.

7. The subminiature imaging optical system of claim 1, wherein the fourth lens has at least one surface formed of an aspherical surface.

8. The subminiature imaging optical system of claim 1, wherein an aperture stop is disposed in front of an object-side surface of the first lens.
